(19) United States
(12) Patent Application Publication
(10) Pub. No.: US 2016/0073830 A1
(43) Pub. Date: Mar. 17, 2016

(54) Toothbrush holder having drying and illuminating means

(71) Applicant: Dephillia McClenon, Houston, TX (US)

(72) Inventor: Dephillia McClenon, Houston, TX (US)

(21) Appl. No.: 14/328,473

(22) Filed: Sep. 16, 2014

(51) Int. Cl. A47K 1/09; F26B 9/00

(52) U.S. Cl. CPC A47K 1/09; F26B 9/003

(57) ABSTRACT

My invention is a toothbrush holder that encompasses the entire toothbrush, with a drying unit that allows air to flow around the bristle of the toothbrush for a quicker dry time and an illuminating light which can be used as a night light. Both of which can be used together or independently of each other.

### BACKGROUND OF THE INVENTION

The toothbrush is a tool for cleaning the teeth and gums having a cluster of hard to reach areas in the mouth. Toothbrushes are available is different bristle textures, sizes and forms. Some toothbrushes even have motors that vibrate or rotate their bristle to make brushing easier and more effective.

Dentist recommends that everyone brush their teeth after meals to prevent tooth decay. Toothpaste is usually applied to the bristle of the toothbrush prior to brushing though, in reality, all is required is water. Generally, teeth and gums are thoroughly brushed in a matter of minutes. Afterward, the toothbrush suspends above the bathroom sink where it is permitted to air dry for hours or days. Nothing usually done to limit the spread of germs to the toothbrush as it waits its next use.

The use of a sink and toilet in a bathroom tends to produce germ-carrying droplets that can travel in a many feet through the air. Not only do these droplets fall floor, countertops, and cabinetry in a bathroom, but they also hit uncovered toothbrushes. Of course, the spread of germs to toothbrushes can cause severe illness and even death. A need, therefore exists for a convenient tool that covers the toothbrush between uses.

### SUMMARY OF THE INVENTION

In light of the problems associated with toothbrushes as they are typically used, it is a principal object of the invention to provide a toothbrush holder that protects the entirety of one toothbrush, either manually operated or electric, from air borne germs. The holder reduces the likelihood of a user of a protected toothbrush becoming sick.

It is another object of my invention to provide a toothbrush holder of a type describe that can provide a drying method for the toothbrush to dry quickly and a holder that can be selectively illuminated so that it can be easily found in dark environments or even serve as a nightlight in homes, dormitory rooms, hospitals etc.

It is another object of my invention to provide a drying unit that allows the toothbrush to dry a lot quicker further reduces the risk of germ borne illness. The drying unit design forces air to move parallel to the center of the shaft around which the blades rotate. Within its limited dimensions and small blade size, it can develop enough pressure up to the head making it ideal for drying the toothbrush bristles.

It is a further object of the invention to provide a toothbrush holder of the type describe that permit air to flow to a protected toothbrush thereby allowing the toothbrush to dry quickly, robbing germs of an aqueous environment within which they might multiply.

It is another object of the invention to provide a toothbrush holder having drying and illuminating means that can be deployed and used with minimal instruction and without having to resort to tools.

It is an object of the invention to provide improved features and arrangements thereof in a toothbrush holder for the purpose described that is: light weight in construction, inexpensive to manufacture, so attractive that it blends into any décor, and dependable in use.

My toothbrush holder achieves the intended objects by featuring a tubular body that is sized to contain a toothbrush. The tubular body is formed of light-transmissive material and has a lower segment and upper segment that are releasable secured together so that the toothbrush can be positioned inside. A weight base is affixed to the bottom of the lower segment. A cap is affixed to the top of the upper segment and is formed of a light-transmissive material. A drying and light source is secured within the top cap.

The foregoing and other objects, feature and advantages of my toothbrush holder will become readily apparent upon considerations of the following description of the preferred holder embodiment illustrated in the accompany drawings.

### BRIEF DESCRIPTION OF THE DRAWINGS

My toothbrush holder can be more readily understood with the reference to accompanying drawings in which:

FIG. 1 is a perspective view of a toothbrush holder in accordance with the present invention

FIG. 2 is an exploded perspective view of the toothbrush holder of FIG. 1

FIG. 3 is a cross-section view of the top portion of the toothbrush holder revealing details of the cap.

FIG. 4 is a cross-sectional view of the middle portion of the toothbrush holder revealing details of the connection between the upper and lower segments of the tubular body.

FIG. 5 is a cross-sectional view of the bottom portion of the toothbrush holder revealing details of the weight base.

FIG. 6 is a schematic electrical circuit diagram of the toothbrush holder.

FIG. 7 is the schematic housing unit for the drying unit

FIG. 8 is the schematic for the fan blades

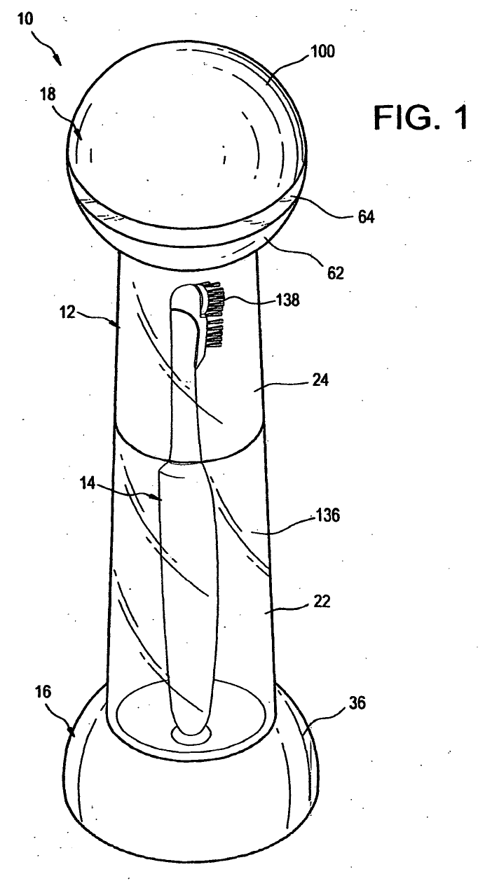

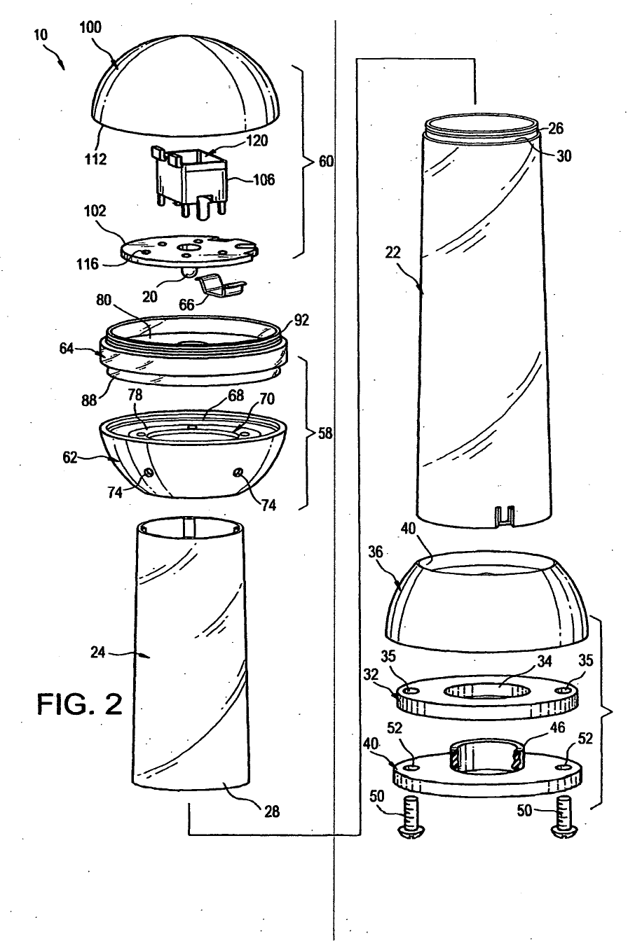

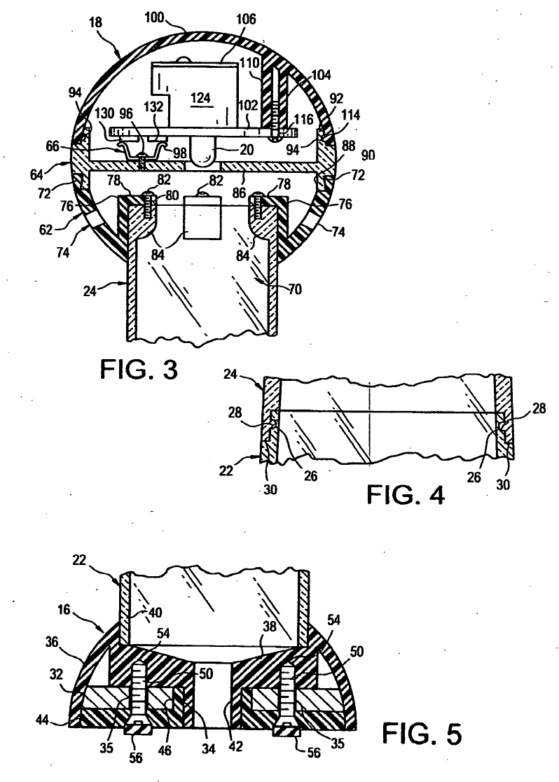

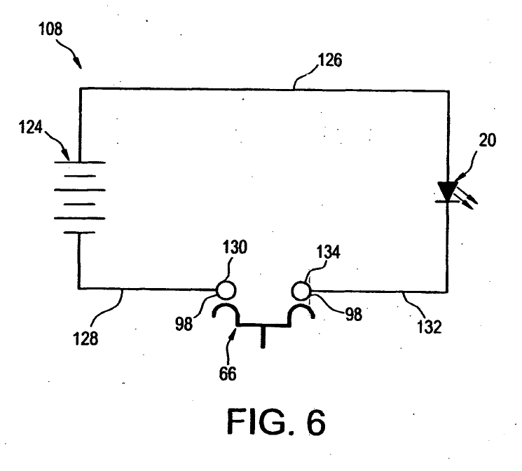

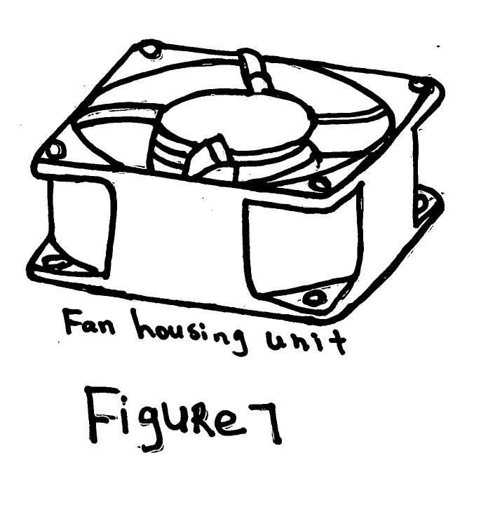

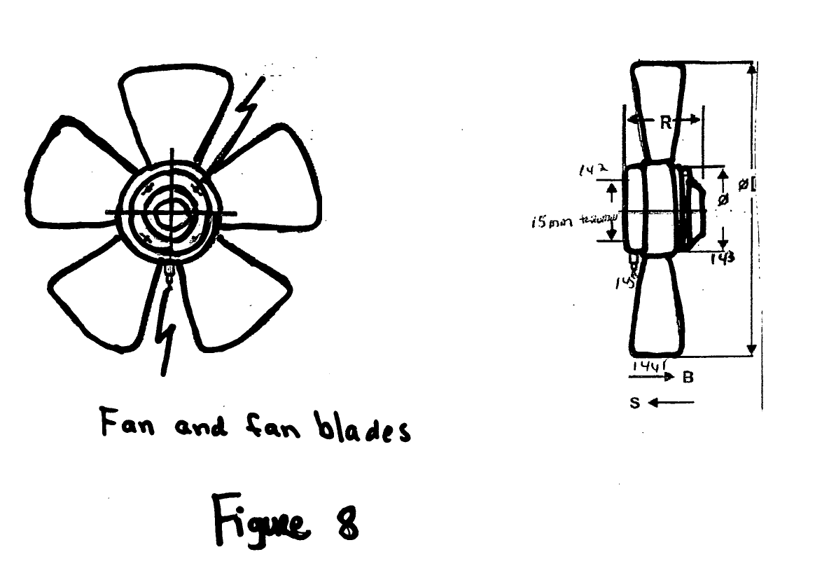

Similar reference characters denote corresponding features consistently throughout the accompanying drawings.

Described above, but encompasses any and all toothbrush holders within the scope of the following

I claim:

1. A toothbrush holder, comprising a tubular body being sized to contain a toothbrush, said tubular body being formed of a light-transmissive material and having a lower segment, and an upper segment with a top of the lower segment being releasably secured to a bottom of said upper segment; a weighted base being affixed to the bottom of said lower segment; a cap being affixed to the top of said upper segment and being formed of a light-transmissive material; and a light source and drying source being secured within the cap.

2. The toothbrush holder according to claim 1 wherein said the upper segment is snap fit onto the lower segment or threaded onto the lower segment.

3. The toothbrush holder according to claim 1 wherein said weighted base has a spout for funneling liquids received from the interior of said tubular body outwardly from the said weighted base.

4. The toothbrush holder according to claim 3 wherein said cap is provided with at least one air vent and drying fan for promoting the circulation of air from said spout and through the tubular body.

5. The toothbrush holder according to claim 1 wherein said light source is a battery-powered LED.

6. The toothbrush holder according to claim 1 wherein said the dry fan is a battery powered fan.

7. A toothbrush holder according to claim 1 wherein said cap includes:
a. A mounting assembly being positioned atop, and being affixed to said upper segment, said mounting assembly including:
b. A switch plate, and, and electrical conductive being secured atop said switch plate, said spring having a pair of leaves extending upwardly from said switch plate; a cover assembly being positioned atop, and being rotatably secured to, said mounting assembly, said cover assembly including: a circuit plate disposed parallel to said switch plate and being adapted for manual rotation above switch plate; an open electrical circuit being secured to said circuit plate, said open electrical circuit including: an electrical current source being secured atop said electrical plate; an LED and drying unit being selectively connected to the bottom of said circuit plate, said contacts being connected in electrical series with said LED and drying fan, said contacts being adapted to touch leaves, close said circuit, and illuminate said LED and dry said dry fan when said circuit plate is manually rotated to a first or second position relative to said switch plate; and said contacts being adapted to not touch to said leaves, open said circuit, and deenergnize said LED and dry fan when said circuit plate is manually rotated to a second position relative to said switch plate.
